(19) United States
(12) Patent Application Publication
(10) Pub. No.: US 2014/0062838 A1
(43) Pub. Date: Mar. 6, 2014

(54) MOBILE E-BINDER SYSTEM

(71) Applicant: Electronics and Telecommunications Research Institute, Daejeon (KR)

(72) Inventors: In-Kyu YOU, Daejeon (KR); Seok-Hwan Moon, Daejeon (KR); Yong-Suk Yang, Daejeon (KR); Soon-Won Jung, Daejeon (KR)

(21) Appl. No.: 13/946,514

(22) Filed: Jul. 19, 2013

(30) Foreign Application Priority Data
Sep. 6, 2012 (KR) 10-2012-0098933
Jan. 24, 2013 (KR) 10-2013-0008103

(51) Int. Cl. G06F 3/14

(52) U.S. Cl. CPC G06F 3/1423
USPC 345/3.1

(57) ABSTRACT

Provided is a mobile e-binder system including at least one display configured to display data, a docking system electrically connected to the at least one display to exchange the data using a standardized communication protocol, and a computing device configured to store and process the data and send the data to the at least one display. The at least one display may be configured to be attachable and detachable to the docking system.

### CROSS-REFERENCE TO RELATED APPLICATIONS

This U.S. non-provisional patent application claims priority under 35 U.S.C. §119 to Korean Patent Application No. 10-2012-0098933 and No. 10-2013-0008103, filed on Sep. 6, 2012 and Jan. 24, 2013, in the Korean Intellectual Property Office, the entire contents of which are hereby incorporated by reference.

### BACKGROUND OF THE INVENTION

Example embodiments of the inventive concept relate to a terminal system, and in particular, to a mobile e-binder system including a plurality of attachable display devices.

Various portable display technologies have been developed to realize a laptop computer, PDA, PMP, a cellular phone, a note pad, and so forth. Recently, thin and flexible display technologies have been developed. Several terminals, whose display performances are different from each other, are used to meet consumers' needs. However, possession of many terminals leads to inconvenience in daily life and eliminate the technical advantage, i.e. portability, of portable display.

It is desired that the display device in the terminal has properties and performance suitable for its purpose. However, there is no need to solve customers' various needs with a single display device. For example, a display device suitable for displaying digital data may not be suitable for showing analog emotion.

### SUMMARY

Example embodiments of the inventive concept provide a mobile e-binder system including a plurality of displays. The displays may be configured to have different functions from each other and to be attachable and detachable.

According to example embodiments of the inventive concepts, a mobile e-binder system may include at least one display configured to display data, a docking system electrically connected to the at least one display to exchange the data using a standardized communication protocol, and a computing device configured to store and process the data and send the data to the at least one display. The at least one display may be configured to be attachable and detachable to the docking system.

In example embodiments, the computing device may include a central processing unit processing the data, a storage storing the data, and a power supplier supplying an electric power to the central processing unit, the storage, and the at least one display.

In example embodiments, the power supplier may include at least one of a portable battery or a wired power supplier.

In example embodiments, the computing device may include an I/O interface for exchanging the data with external devices.

In example embodiments, the computing device may include an optical disc interface for exchanging the data with an optical disc medium.

In example embodiments, the computing device may include a wireless communication device for exchanging the data with external devices in a wireless manner.

In example embodiments, the docking system may include at least one of a D-ring, a clip, or a slid groove.

In example embodiments, the at least one display may be operated using at least one operation mechanism of LCD, OLED, or e-ink.

In example embodiments, the at least one display may be configured to have at least one of flexibility or foldability.

In example embodiments, the at least one display may include a central processing unit configured to execute an additional calculation, a storage configured to input and output the data with an operation speed faster than a storage of the computing device, and a power supplier supplying an electric power to the at least one display.

In example embodiments, the at least one display may include at least one of a microphone for inputting voice or a speaker for outputting voice.

In example embodiments, the at least one display may include at least one inputting device of a touch screen or a pen-type inputting device.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a perspective view illustrating a mobile e-binder system according to a first embodiment of the inventive concept.

FIG. 2 is a perspective view illustrating a mobile e-binder system according to a second embodiment of the inventive concept.

FIG. 3 is a schematic diagram illustrating the display in FIG. 1 or 2.

FIG. 4 is a plan view illustrating a docking system of a mobile e-binder system according to an embodiment of the inventive concept.

FIG. 5 is a perspective view illustrating a docking system according to a first embodiment of the inventive concept.

FIG. 6 is a perspective view illustrating a docking system according to a second embodiment of the inventive concept.

FIG. 7 is a perspective view illustrating a docking system according to a third embodiment of the inventive concept.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments of the inventive concepts are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments of the inventive concepts should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments of the inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

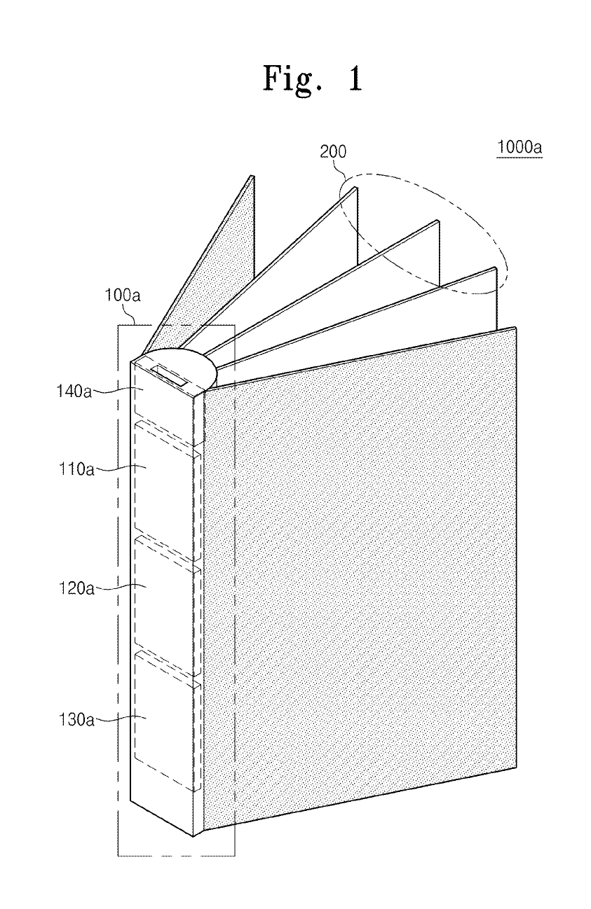

FIG. 1 is a perspective view illustrating a mobile e-binder system according to a first embodiment of the inventive concept. Referring to FIG. 1, a mobile e-binder system 1000a may be provided in a form of the book or a binder. A computing device 100a may be located at one side of the mobile e-binder system 1000a. The computing device 100a may be connected to a plurality of displays 200 via an additional interface.

The computing device 100a may be configured to store and process data, and the processed data may be displayed by the displays 200. The computing device 100a may include a central processing unit 110a, a storage 120a, a power supplier 130a, and an I/O interface 140a.

The central processing unit 110a may be configured to control the mobile e-binder system 1000a. Further, the central processing unit 110a may be configured to control the storage 120a, the power supplier 130a, the I/O interface 140a, and the displays 200. The central processing unit 110a may be configured to process data input thereto, and the processed data may be displayed by the displays 200.

The storage 120a may be configured to store data input from the I/O interface 140a and/or the displays 200. The displays 200 may include a data inputting device, such as a touch screen, and thus, they may serve as a user interface device. Although not shown in the drawings, in the case where a wireless communication device is provided, data transmitted from the wireless communication device may be stored in the storage 120a. In example embodiments, the storage 120a may be one of various storing media, such as FLASH memory device, HDD, and SSD.

The power supplier 130a may supply an electric power for operating the mobile e-binder system 1000a. In example embodiments, the power supplier 130a may be one of various power supplying devices, such as a portable battery and a wired power supplier.

The I/O interface 140a may be configured to input and output data to and from the outside. The I/O interface 140a may be configured to meet one of various I/O standards, such as USB, IEEE1394, and thunderbolt.

The displays 200 may be configured to display data that are processed by the computing device 100a. The displays 200 may be configured to be attachable and detachable. The displays 200 and the computing device 100a may be connected to each other by an additional interface. Although three displays 200 are exemplarily depicted in the drawings, the number of the displays 200 to be connected to the computing device 100a may be changed. The displays 200 may include a data inputting device, such as a touch screen, and thus, it may serve as a user interface device.

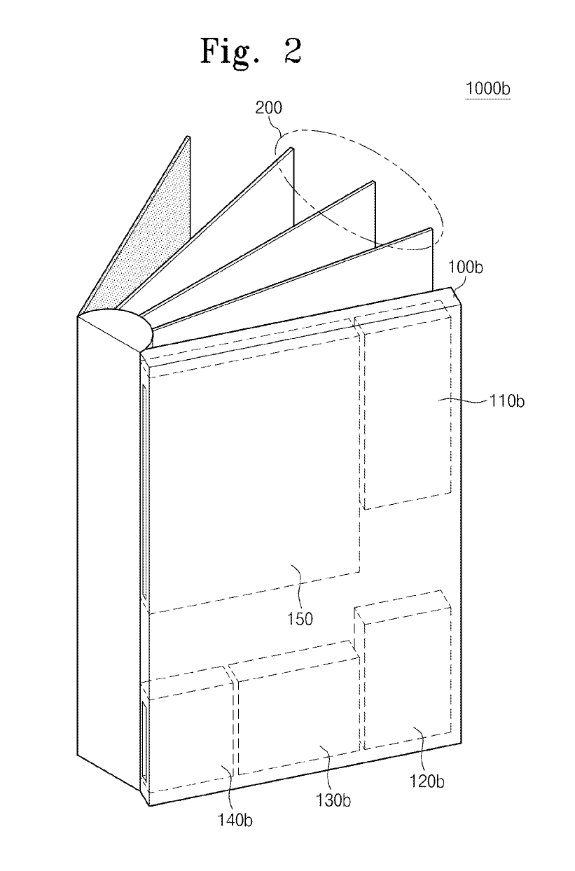

FIG. 2 is a perspective view illustrating a mobile e-binder system according to a second embodiment of the inventive concept. Referring to FIG. 2, a mobile e-binder system 1000b may be provided in a form of the book or a binder. A computing device 100b may be provided in a front or back cover of the mobile e-binder system 1000b. The computing device 100b may be connected to a plurality of displays 200 via an additional interface.

The computing device 100b may be configured to store and process data, and the processed data may be displayed by the displays 200. The computing device 100b may include a central processing unit 110b, a storage 120b, a power supplier 130b, an I/O interface 140b, and an ODD interface 150.

The central processing unit 110b may be configured to control the mobile e-binder system 1000b. The central processing unit 110b may be configured to control the storage 120b, the power supplier 130b, the I/O interface 140b, the ODD interface 150, and the displays 200. The central processing unit 110b may be configured to process data input thereto, and the processed data may be displayed by the displays 200.

The storage 120b may be configured to store data input from the I/O interface 140b, the ODD interface 150, and/or the displays 200. The displays 200 may include a data inputting device, such as a touch screen, and thus, they may serve as a user interface device. Although not shown in the drawings, in the case where a wireless communication device is provided, data transmitted from the wireless communication device may be stored in the storage 120b. In example embodiments, the storage 120b may be one of various storing media, such as FLASH memory device, HDD, and SSD.

The power supplier 130b may supply an electric power for operating the mobile e-binder system 1000b. In example embodiments, the power supplier 130b may be one of various power supplying devices, such as a portable battery and a wired power supplier.

The I/O interface 140b may be configured to input and output data to and from the outside. The I/O interface 140b may be configured to meet one of various I/O standards, such as USB, IEEE1394, and thunderbolt.

The ODD interface 150 may be configured to input and output data to and from an optical disc, such as CD, DVD, and Blu-ray disc. Various optical disc drives, such as CD, DVD and Blu-ray drive, may be used for the ODD interface 150.

The displays 200 may be configured to display data that are processed by the computing device 100b. The displays 200 may be configured to be attachable and detachable. The displays 200 and the computing device 100b may be connected to each other by an additional interface. Although three displays 200 are exemplarily depicted in the drawings, the number of the displays 200 to be connected to the computing device 100b may be changed. The displays 200 may include a data inputting device, such as a touch screen, and thus, they may serve as a user interface device.

So far, basic features of the mobile e-binder systems 1000a and 1000b have been described. As described above, the mobile e-binder systems 1000a and 1000b may be configured in such a way that the displays 200 are attachable and detachable, and this makes it possible to improve functionality and portability of the mobile e-binder systems. Further, although not shown, the computing device 100a or 100b may be configured to provide a wireless communication function, such as wireless communication and Wi-Fi. In addition, the mobile e-binder system 1000a and 1000b may include an additional display screen, which may be provided on a cover of the system to display information related to its owner.

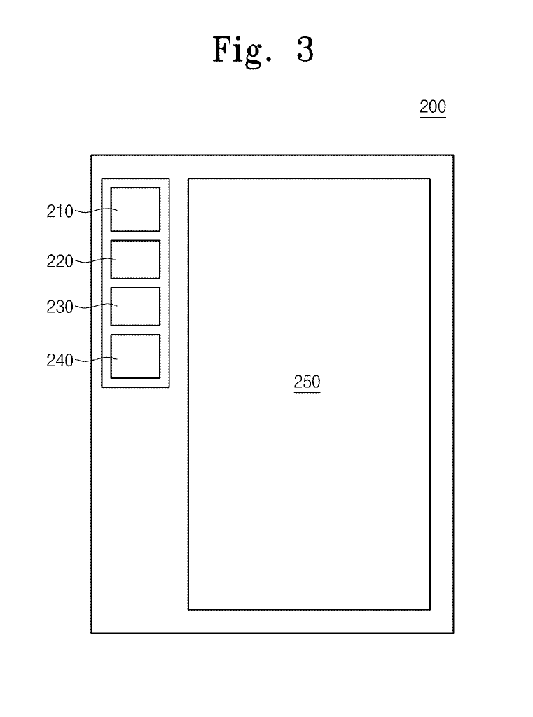

FIG. 3 is a schematic diagram illustrating the display in FIG. 1 or 2. A display 200 may include a central processing unit 210, a storage 220, a power supplier 230, a slave data interface 240, and a screen 250. The display 200 may be configured in such a way that data transmitted through the slave data interface 240 is processed by the central processing unit 210 and the storage 220 and is displayed through the screen 250. However, in an application for displaying simple information, the display 200 may be configured to include the slave data interface 240 and the screen 250. The display 200 may be configured to be attachable and detachable to the computing device 100 (e.g., of FIGS. 1 and 2). The display 200 may have various structures and shapes, according to its purpose and function, and be realized in various manners. Further, although not shown, the display 200 may be configured to include at least one of various components, according to its purpose and function. For example, if it is used for education, the display 200 may be designed or configured to be suitable for a subject related thereto. If it is used for displaying a multimedia content, such as music and movie, the display 200 may be configured to include at least one of various components, as a speaker and a microphone. If data should be input, an inputting device, a touch screen and a pen, may be applied for the display 200.

The central processing unit 210 may be configured to control each part of the display 200. The central processing unit 210 of the display 200 may be configured to improve performance of the display 200, unlike the central processing unit 110 of the computing device 100. For example, the central processing unit 210 may be configured to have an improved graphic function, thereby providing high-quality image. In other embodiments, the central processing unit 210 may be configured to have an improved calculation function, thereby providing fast calculation ability to users.

The storage 220 may be configured to store data, and this makes it possible to operate the display 200 quickly. The storage 220 may store date transmitted from the computing device 100, and this makes it possible to improve an operation speed of the display 200. In example embodiments, the storage 220 may be realized using a memory device having a small size and a fast response speed.

The power supplier 230 may be configured to supply an electric power to the display 200. The power supplier 230 may supply an electric power for operating the central processing unit 210 and the storage 220.

The slave data interface 240 may be connected to the computing device 100, thereby executing a data exchange operation. The display 200 may receive data through the slave data interface 240 and display the data through the screen 250. The display 200 may include a data inputting device, such as a touch screen, and data input through the display 200 may be transmitted to the computing device 100 through the slave data interface 240.

The screen 250 may be configured to display data that are processed by the computing device 100. The screen 250 may be configured to have flexibility and foldability, according to its purpose and function. Accordingly, a structure of the screen 250 may be variously modified. Further, various display technologies, such as LCD, OLED, and e-ink, may be used to realize the screen 250, but example embodiments of the inventive concepts may not be limited thereto.

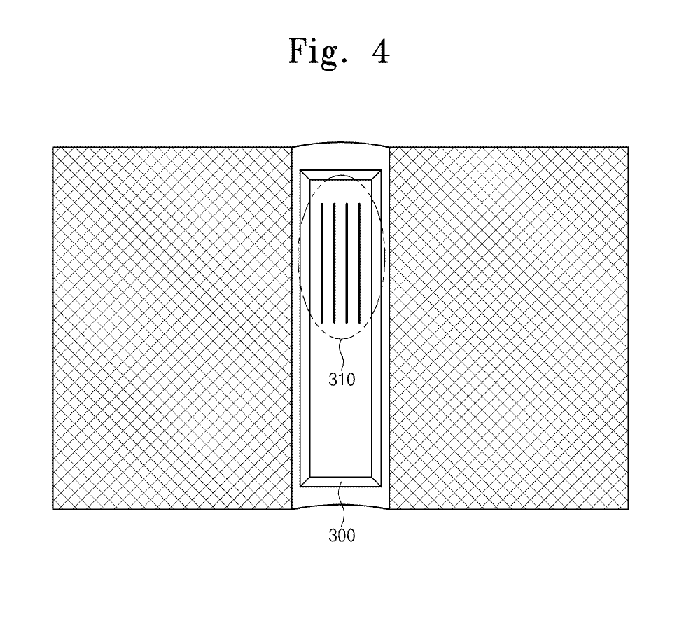

FIG. 4 is a plan view illustrating a docking system of a mobile e-binder system according to an embodiment of the inventive concept. Referring to FIG. 4, a docking system 300 may be provided at a central portion of the mobile e-binder system 1000, when the mobile e-binder system 1000 is open. The docking system 300 may include a master data interface 310. The master data interface 310 may be connected to the slave data interface 240 of the display 200. The master and slave data interfaces 310 and 240 may be connected to each other by a standardized communication protocol, such as USB. Data processed by the computing device 100 may be transmitted to the display 200 through the master and slave data interfaces 310 and 240. The display 200 may include a data inputting device, such as a touch screen, and data input through the display 200 may be transmitted to the computing device 100 through the master and slave data interfaces 310 and 240.

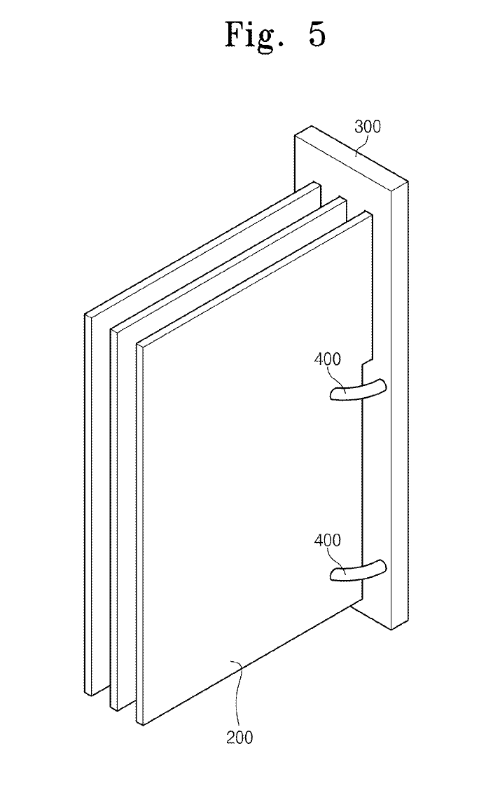

The docking system 300 may be configured to fasten the displays 200. Hereinafter, ways of fastening the display with the docking system 300 will be described in more detail with reference to FIGS. 5 through 7. Although three displays 200 are exemplarily depicted in FIGS. 5 through 7, it is obvious for skilled persons that the number of the displays 200 can be changed.

FIG. 5 is a perspective view illustrating a docking system according to a first embodiment of the inventive concept. Referring to FIG. 5, a D-ring 400 may be used to fasten the displays 200 to the docking system 300. Each of the displays 200 may have at least one hole that is fittingly formed at a position of the D-ring 400. Similar to a typical binder, the D-ring 400 may be configured in such a way that both portions thereof are separated from each other. In this case, the slave data interface 240 of the display 200 may be inserted into the master data interface 310 of the docking system 300, in such a way that the hole of the display 200 is fittingly engaged with the D-ring 400. Thereafter, the D-ring 400 may be closed to fasten the displays 200.

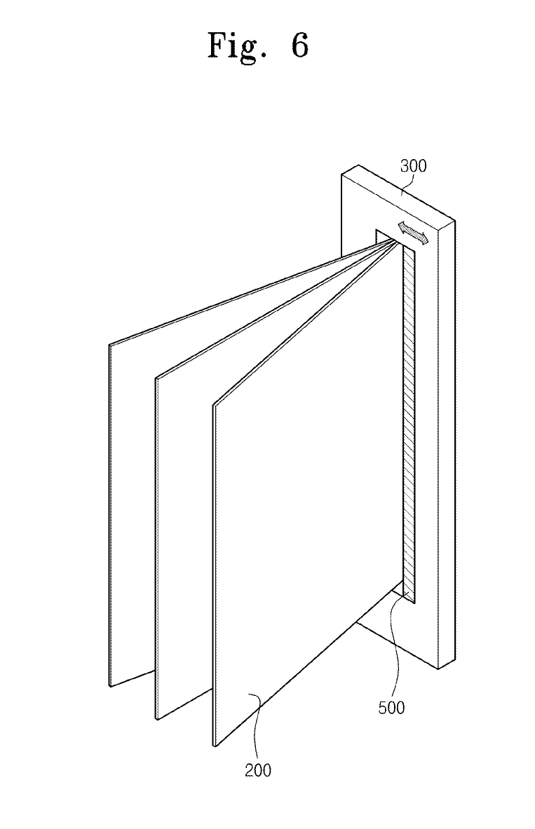

FIG. 6 is a perspective view illustrating a docking system according to a second embodiment of the inventive concept. Referring to FIG. 6, the docking system 300 may fasten the displays 200 in a clip manner. The docking system 300 may include a clip 500, which is configured to move along a direction of an arrow. The clip 500 may be moved toward the right to be open, and then, the displays 200 may be disposed at a groove portion of the docking system 300. Thereafter, the clip 500 may be moved toward the left to fasten the displays 200. The movement of the clip 500 may be manually or automatically operated. In the case where the displays 200 are disposed at the groove portion of the docking system 300, the master and slave data interfaces 310 and 240 may be located at the same position and thus, they may be connected to each other.

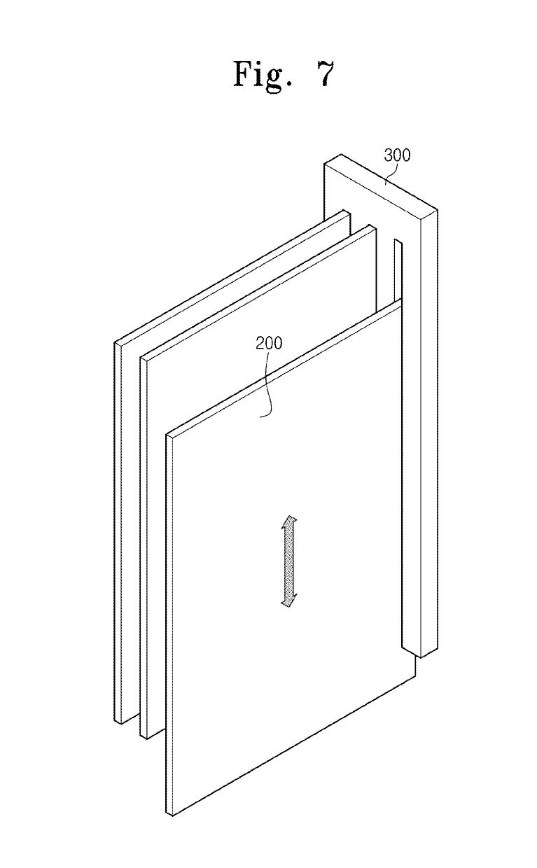

FIG. 7 is a perspective view illustrating a docking system according to a third embodiment of the inventive concept. Referring to FIG. 7, the docking system 300 may fasten the displays 200 in a slide manner. The docking system 300 may be formed to have at least one groove, in which the display 200 can be inserted. The displays 200 may be moved or slid along a vertical direction, as shown by an arrow. The displays 200 may be inserted from bottom to top along the groove. Alternatively, the displays 200 may be inserted from top to bottom along the groove. If the displays 200 are inserted to the end of the groove, they may be fastened. In addition, the master and slave interfaces 310 and 240 may be located at the same position and be connected to each other.

So far, the ways of fastening the display 200 to the docking system 300 have been described, but example embodiments of the inventive concepts may not be limited thereto. The afore-described three fastening ways may be various modified. According to example embodiments of the inventive concept, the docking system 300 may be connected to the displays 200 through the interface and be configured to fasten the displays 200.

According to example embodiments of the inventive concept, the mobile e-binder system may be configured to include a plurality of displays. The displays may be configured to have different functions from each other and to be attachable and detachable. Accordingly, it is possible to realize a multi-functional mobile e-binder system. For example, the mobile e-binder system may be configured to satisfy digital and analog emotions of users.

While example embodiments of the inventive concepts have been particularly shown and described, it will be understood by one of ordinary skill in the art that variations in form and detail may be made therein without departing from the spirit and scope of the attached claims.

What is claimed is:

1. A mobile e-binder system, comprising:
at least one display configured to display data;
a docking system electrically connected to the at least one display to exchange the data using a standardized communication protocol; and
a computing device configured to store and process the data and send the data to the at least one display,
wherein the at least one display is configured to be attachable and detachable to the docking system.

2. The mobile e-binder system of claim 1, wherein the computing device comprises:
a central processing unit processing the data;
a storage storing the data; and
a power supplier supplying an electric power to the central processing unit, the storage, and the at least one display.

3. The mobile e-binder system of claim 2, wherein the power supplier comprises at least one of a portable battery or a wired power supplier.

4. The mobile e-binder system of claim 2, wherein the computing device comprises an I/O interface for exchanging the data with external devices.

5. The mobile e-binder system of claim 2, wherein the computing device comprises an optical disc interface for exchanging the data with an optical disc medium.

6. The mobile e-binder system of claim 2, wherein the computing device comprises a wireless communication device for exchanging the data with external devices in a wireless manner.

7. The mobile e-binder system of claim 1, wherein the docking system comprises at least one of a D-ring, a clip, or a slid groove.

8. The mobile e-binder system of claim 1, wherein the at least one display is operated using at least one operation mechanism of LCD, OLED, or e-ink.

9. The mobile e-binder system of claim 1, wherein the at least one display is configured to have at least one of flexibility or foldability.

10. The mobile e-binder system of claim 1, wherein the at least one display comprises:
a central processing unit configured to execute an additional calculation;
a storage configured to input and output the data with an operation speed faster than a storage of the computing device; and
a power supplier supplying an electric power to the at least one display.

11. The mobile e-binder system of claim 1, wherein the at least one display comprises at least one of a microphone for inputting voice or a speaker for outputting voice.

12. The mobile e-binder system of claim 1, wherein the at least one display comprises at least one inputting device of a touch screen or a pen-type inputting device.
